(19) United States
(12) Patent Application Publication
(10) Pub. No.: US 2020/0340440 A1
(43) Pub. Date: Oct. 29, 2020

(54) DC MOTOR

(71) Applicant: DENSO CORPORATION, Kariya-City (JP)

(72) Inventor: Tatsuya FUJITA, Kariya-City (JP)

(73) Assignee: DENSO CORPORATION, Kariya-City (JP)

(21) Appl. No.: 16/857,256

(22) Filed: Apr. 24, 2020

(30) Foreign Application Priority Data
Apr. 24, 2019 (JP) 2019-083429

(51) Int. Cl. F02N 11/02

(52) U.S. Cl. CPC F02N 11/02

(57) ABSTRACT

A brushed DC includes a housing, a motor shaft, a cap, a restricting member and a spacer. The housing has a cylindrical portion with an axial end surface. The motor shaft has a protruding portion protruding from the cylindrical portion of the housing and an annular groove formed in an outer circumferential surface of the protruding portion. The cap is mounted to the cylindrical portion of the housing with an opposing surface of the cap opposed to the axial end surface of the cylindrical portion. The restricting member is mounted in the groove of the motor shaft and fixed between the axial end surface and the opposing surface to restrict axial movement of the motor shaft. The spacer is interposed, in a state of having been plastically deformed in an axial direction of the motor shaft during the mounting of the cap, between the opposing surface and the restricting member.

### CROSS-REFERENCE TO RELATED APPLICATION

This application is based on and claims priority from Japanese Patent Application No. 2019-083429 filed on Apr. 24, 2019, the contents of which are hereby incorporated by reference in their entirety into this application.

### BACKGROUND

### 1 Technical Field

The present disclosure relates to brushed DC motors employed in, for example, starters for starting internal combustion engines.

### 2 Description of Related Art

In starters for starting internal combustion engines, there are employed brushed DC motors. In these DC motors, if the motor shaft is moved in the axial direction due to vibration or the like during, for example, the engine cranking, wear of the motor brushes may progress due to the axial movement of the motor shaft. To solve this problem, various motor configurations have been developed.

### SUMMARY

According to the present disclosure, there is provided a brushed DC motor for a starter of an internal combustion engine. The DC motor includes a housing, a motor shaft, a cap, a restricting member and a spacer. The housing has a hollow cylindrical portion in which a bearing is fixed. The cylindrical portion has an axial end surface. The motor shaft is rotatably supported by the housing via the bearing. The motor shaft has a protruding portion that protrudes from the cylindrical portion of the housing so as to be located outside the housing. The motor shaft also has an annular groove formed in an outer circumferential surface of the protruding portion. The cap is mounted to the cylindrical portion of the housing to cover the protruding portion of the motor shaft. The cap has an opposing surface opposed to the axial end surface of the cylindrical portion of the housing. The restricting member is mounted in the annular groove of the motor shaft and fixed between the axial end surface of the cylindrical portion of the housing and the opposing surface of the cap to restrict axial movement of the motor shaft. The spacer is interposed, in a state of having been plastically deformed in an axial direction of the motor shaft during the mounting of the cap to the cylindrical portion of the housing, between the opposing surface of the cap and the restricting member in the axial direction.

### BRIEF DESCRIPTION OF THE DRAWINGS

FIG. 1 is a partially cross-sectional view of a starter which includes a brushed DC motor according to an exemplary embodiment.

FIG. 2 is an enlarged cross-sectional view of a part II of FIG. 1.

FIG. 3 is a cross-sectional view, taken along a plane perpendicular to an axial direction, of a motor shaft of the DC motor with a restricting member assembled to the motor shaft.

FIG. 4 is a longitudinal cross-sectional view of a cap of the DC motor.

FIG. 5 is a lateral cross-sectional view of the cap taken along the line V-V in FIG. 4.

FIG. 6 is a side view of a second spacer of the DC motor which is interposed between an opposing surface of the cap and the restricting member.

FIG. 7 is a cross-sectional view illustrating a comparative example where a cap is mounted to a cylindrical portion of a rear cover without any spacer interposed therebetween.

FIG. 8 is a cross-sectional view illustrating the cap of the DC motor according to the exemplary embodiment before being mounted to a cylindrical portion of a rear cover of the DC motor.

FIG. 9 is a cross-sectional view illustrating the cap of the DC motor according to the exemplary embodiment in a state of being mounted to the cylindrical portion of the rear cover.

FIG. 10 is a cross-sectional view illustrating the cap of the DC motor according to the exemplary embodiment which has been mounted, in a state of being oblique to the motor shaft, to the cylindrical portion of the rear cover.

FIG. 11 is a side view illustrating a restricting member according to a modification in a state of being pressed by a cap via a second spacer interposed therebetween.

### DESCRIPTION OF EMBODIMENTS

There is known, for example from German Patent Application Publication No. DE 102011084235 A1, a brushed DC motor that is configured to restrict axial movement of the motor shaft. Specifically, in this DC motor, an annular groove is formed in an outer circumferential surface of an exposed portion of the motor shaft which is exposed from a housing of the DC motor. Moreover, a C-shaped washer is fitted in the annular groove and held in a pressed state between the housing and a cap. Consequently, with the washer, it is possible to restrict axial movement of the motor shaft.

However, when the washer is pressed by the cap against the housing during the assembly of the known DC motor, at least one of an end surface of the cap and an end surface of the housing, which are opposed to each other, may become not perpendicular to the motor shaft. For example, depending on the assembly accuracy, the cap may be mounted to the housing so that the end surface of the cap becomes not perpendicular to the motor shaft. In this case, the washer is fixed to be oblique (i.e., not perpendicular) to the motor shaft, causing axial runout (or deviation) of the motor shaft.

In contrast, in the above-described brushed DC motor according to the present disclosure, between the opposing surface of the cap and the restricting member, there is interposed the spacer which has been plastically deformed in the axial direction of the motor shaft during the mounting of the cap to the cylindrical portion of the housing. Therefore, even when the opposing surface of the cap is non-parallel to the axial end surface of the cylindrical portion of the housing during the mounting of the cap to the cylindrical portion, the spacer can be plastically deformed to have its axial thickness changed at any position in the circumferential direction, thereby allowing the restricting member to be pressed over the entire circumferential range thereof by the cap. Consequently, it becomes possible to have the restricting member fixed to be perpendicular to the motor shaft while having both the opposing surface of the cap and the axial end surface of the cylindrical portion of the housing adhered to the restricting member without any gap formed between the surfaces and the restricting member. As a result, it becomes possible to suppress axial runout of the motor shaft.

In further implementations, the DC motor may further include, while the above-described spacer is a cap-side spacer, a housing-side spacer that is interposed, in a state of having been plastically deformed in the axial direction of the motor shaft during the mounting of the cap to the cylindrical portion of the housing, between the axial end surface of the cylindrical portion of the housing and the restricting member in the axial direction.

The axial end surface of the cylindrical portion of the housing may be oblique to the motor shaft due to, for example, manufacturing tolerances. In this case, with the housing-side spacer interposed between the axial end surface and the restricting member, it is still possible to reliably ensure the perpendicularity of the restricting member to the motor shaft through the plastic deformation of the housing-side spacer during the mounting of the cap to the cylindrical portion of the housing.

Moreover, to minimize axial runout of the motor shaft, it is preferable to press, during the mounting of the cap to the cylindrical portion of the housing, the cap-side spacer against the restricting member with the restricting member abutting a housing-side wall surface of the groove. If there is no housing-side spacer interposed between the axial end surface of the cylindrical portion and the restricting member, upon a radially outer part of the restricting member being pressed by the cap via the cap-side spacer with a radially inner part of the restricting member abutting the housing-side wall surface of the groove, the restricting member may be warped. In this regard, by interposing the housing-side spacer between the axial end surface of the cylindrical portion and the restricting member, it is possible to prevent the restricting member from being warped.

It is preferable for the cap-side spacer to be configured to be more easily plastically deformable than the housing-side spacer.

During the mounting of the cap to the cylindrical portion of the housing, it is easier for the opposing surface of the cap to become oblique to the motor shaft (due to, for example, assembly errors) than for the axial end surface of the cylindrical portion to become oblique to the motor shaft. However, by configuring the cap-side spacer to be more easily plastically deformable than the housing-side spacer, it becomes possible to reliably suppress the influence of obliqueness of the opposing surface of the cap to the motor shaft on the restricting member.

The restricting member may be substantially C-shaped and arranged around the motor shaft. The cap-side spacer may have a plurality of plastically-deformable portions formed in circumferential alignment with each other. Those of the plurality of plastically-deformable portions which abut the restricting member in the axial direction of the motor shaft may be in the state of having been plastically deformed in the axial direction during the mounting of the cap to the cylindrical portion of the housing.

With the above configuration, in the case of the cap being oblique to the motor shaft during the mounting of the cap to the cylindrical portion of the housing, the load imposed on the plastically-deformable portions and thus the degrees of the plastically-deformable portions being crushed by the load vary depending on the circumferential positions thereof. Consequently, with the plastically-deformable portions of the cap-side spacer being crushed in different degrees, it becomes possible to absorb the obliqueness of the opposing surface of the cap to the motor shaft.

Otherwise, the restricting member may be annular-shaped and have a non-abutting portion. The non-abutting portion may be formed within a given circumferential range so as not to abut the spacer. The restricting member may abut the spacer over an entire circumferential range of the restricting member except for the given circumferential range of the non-abutting portion.

With the above configuration, part of the cap-side spacer is pressed into the non-abutting portion of the restricting member during the mounting of the cap to the cylindrical portion of the housing, thereby functioning as a positioning member to position the restricting member in the circumferential direction. Consequently, the restricting member can be fixed at a predetermined position without being displaced therefrom.

An exemplary embodiment will be described hereinafter with reference to the drawings.

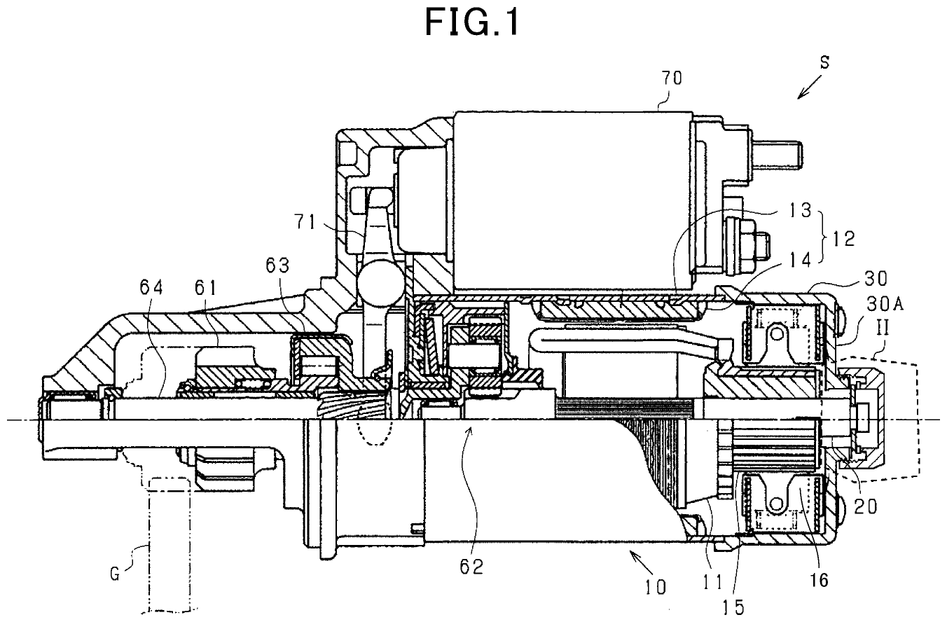

FIG. 1 shows the overall structure of a starter S that includes a DC motor 10 according to the exemplary embodiment.

In the present embodiment, the starter S is designed to be used in a vehicle to start an internal combustion engine of the vehicle.

As shown in FIG. 1, the starter S includes the DC motor 10, a speed reducer 62 that is configured to transmit rotation of the DC motor 10, through speed reduction, to a pinion gear 61, and a magnetic switch 70 that is configured to selectively make and break electrical connection for supplying electric power to the DC motor 10.

The DC motor 10 is a brushed DC (Direct Current) motor. The DC motor 10 includes a rotor 11 that serves as an armature, and a stator 12 that is provided radially outside the rotor 11 and serves as a field.

The rotor 11 includes a rotor core, a rotor coil (or armature coil) wound on the rotor core, a commutator 15 electrically connected with the rotor coil, and a motor shaft (or rotating shaft) 20 which is centered in the rotor 11 and on which the rotor core is fixed.

On the radially outer side of the commutator 15, there are arranged brushes 16 in sliding contact with an outer circumferential surface of the commutator 15. In operation, electric power is supplied from a battery (not shown) to the rotor coil via the sliding contact between the brushes 16 and the commutator 15, thereby generating magnetic force in the rotor core.

The stator 12 includes a cylindrical yoke 13 and a plurality of permanent magnets 14 fixed on an inner circumferential surface of the yoke 13. To an axial end of the yoke 13 on the opposite side to the pinion gear 61, there is fixed a rear cover 30. The permanent magnets 14 are arranged around the rotor core so as to face an outer circumferential surface of the rotor core. In operation, interaction between the permanent magnets 14 and the magnetic force generated in the rotor core causes the rotor 11 to rotate relative to the stator 12.

The speed reducer 62 is provided on an end portion of the motor shaft 20 on the pinion gear 61 side. The speed reducer 62 is implemented by, for example, a planetary gear mechanism.

The motor shaft 20 of the DC motor 10 drives a drive shaft 64 through speed reduction by the speed reducer 62. On the drive shaft 64, there are mounted the pinion gear 61 and a one-way clutch 63. Consequently, with rotation of the motor shaft 20, the pinion gear 61 also rotates.

In addition, as an alternative, the starter S may include no speed reducer and the motor shaft 20 may serve as a drive shaft.

The magnetic switch 70 includes: an excitation coil (or solenoid); a plunger slidably provided on an inner periphery of the excitation coil; a fixed core; a movable contact held by the plunger; and a pair of fixed contacts provided inside the magnetic switch 70 and respectively connected with a battery-side terminal and a motor-side terminal. The battery-side terminal is electrically connected to the battery while the motor-side terminal is electrically connected to the DC motor 10.

In operation, the excitation coil is energized when electric current is supplied from the battery to a switch terminal upon an ignition switch being turned on by, for example, a key operation by a user. Upon energization of the excitation coil, the plunger is attracted by the fixed core, causing a shift lever 71 to shift the pinion gear 61 to an opposite side to the DC motor 10 and thereby bring the pinion gear 61 into mesh with a ring gear G of the engine. Moreover, upon the plunger being attracted by the fixed core, the movable contact is brought into contact with the pair of fixed contacts, causing electric power to be supplied from the battery to the DC motor 10 via the battery-side terminal and the motor-side terminal. Consequently, the DC motor 10 rotates with the electric power supplied from the battery; the rotation of the DC motor 10 is transmitted to the ring gear G of the engine via the speed reducer 62, the one-way clutch 63 and the pinion gear 61, thereby starting the engine.

Next, the structure of the DC motor 10 for suppressing axial runout of the motor shaft 20 will be described with reference to FIGS. 1-3.

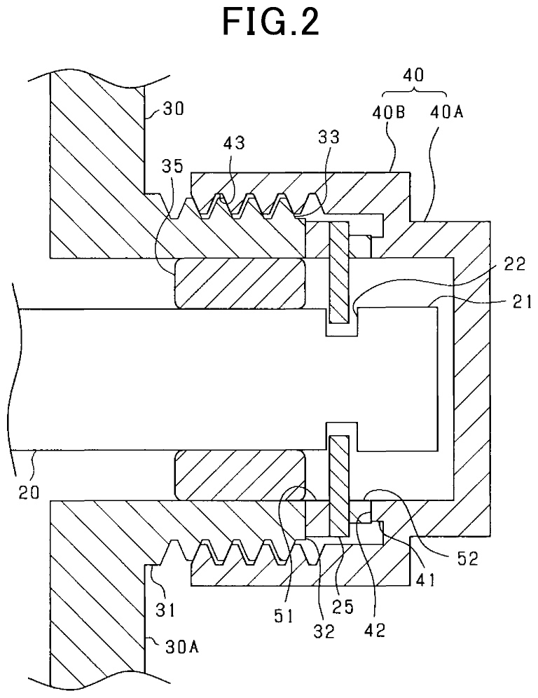

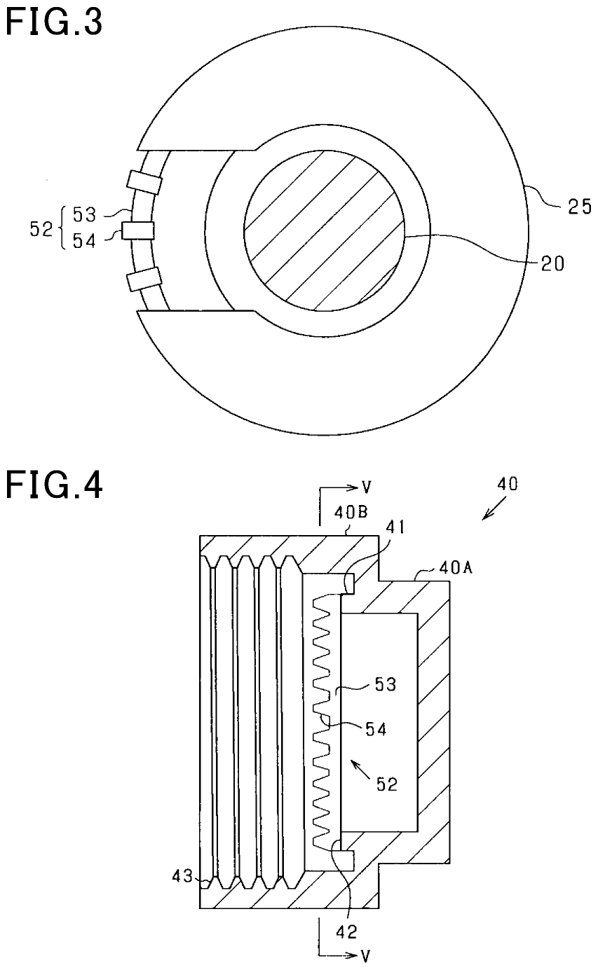

FIG. 2 shows components of the DC motor 10 provided around an end portion of the motor shaft 20 on the opposite side to the pinion gear 61. FIG. 3 shows a cross section of the motor shaft 20 perpendicular to an axial direction thereof with a restricting member 25 assembled to the motor shaft 20. It should be noted that hereinafter, the pinion gear 61 side (i.e., the left side in FIGS. 1 and 2) in the axial direction of the motor shaft 20 will be referred to as the front side; and the opposite side to the pinion gear 61 (i.e., the right side in FIGS. 1 and 2) will be referred to as the rear side.

The rear cover 30 has a bottomed cylindrical shape and is arranged to cover a rear end part of the DC motor 10. It should be noted that the rear cover 30 may be formed integrally with the yoke 13 as one piece. In addition, the rear cover 30 corresponds to a “housing” of the DC motor 10.

The rear cover 30 has a bottom wall 30A which includes a rear end surface of the rear cover 30 perpendicular to the axial direction of the motor shaft 20. The rear cover 30 also has a hollow cylindrical portion 31 which is formed on the bottom wall 30A so as to protrude backward from the bottom wall 30A and through which the rear end portion of the motor shaft 20 extends.

The cylindrical portion 31 has its rear end surface formed as an axial end surface 32 perpendicular to the axial direction of the motor shaft 20. In the cylindrical portion 31, there is fixed a bearing 35 for rotatably supporting the motor shaft 20. That is, the motor shaft 20 is rotatably supported by the rear cover 30 via the bearing 35 provided in the cylindrical portion 31 of the rear cover 30.

Part of the rear end portion of the motor shaft 20 protrudes backward from the cylindrical portion 31 of the rear cover 30, forming a protruding portion 21 of the motor shaft 20. In an outer circumferential surface of the protruding portion 21, there is formed an annular groove 22.

In the annular groove 22 of the motor shaft 20, there is mounted the restricting member 25 to restrict axial movement of the motor shaft 20. The restricting member 25 has a thickness (or axial dimension) smaller than the width (or axial dimension) of the groove 22. That is, there is a given clearance between the groove 22 and the restricting member 25.

As shown in FIG. 3, in the present embodiment, the restricting member 25 is formed of an annular plate and partially cut out in a given circumferential range thereof so as to be placed into the annular groove 22 of the motor shaft 20. That is, the restricting member 25 is substantially C-shaped in plan view.

To the cylindrical portion 31 of the rear cover 30, there is mounted a cap 40 to cover the protruding portion 21 of the motor shaft 20 which protrudes outside the cylindrical portion 31. The cap 40 has a bottomed cylindrical shape.

Specifically, the cap 40 has a small-diameter portion 40A that covers the protruding portion 21 of the motor shaft 20 from the rear side, and a large-diameter portion 40B that is mounted to the cylindrical portion 31 of the rear cover 30. The outer and inner diameters of the large-diameter portion 40B are set to be respectively larger than those of the small-diameter portion 40A so that there is formed an inner shoulder between the inner circumferential surfaces of the small-diameter and large-diameter portions 40A and 40B. Moreover, on the inner shoulder, there is formed a protrusion 41 to protrude forward.

The protrusion 41 has a front end surface which constitutes an opposing surface 42 of the cap 40. The opposing surface 42 is opposed to and thus faces the axial end surface 32 of the cylindrical portion 31 of the rear cover 30 after the cap 40 is mounted to the cylindrical portion 31.

In the inner circumferential surface of the large-diameter portion 40B of the cap 40, there is formed a female threaded portion 43. On the other hand, in the outer circumferential surface of the cylindrical portion 31 of the rear cover 30, there is formed a male threaded portion 33. The large-diameter portion 40B of the cap 40 is mounted to the cylindrical portion 31 of the rear cover 30 by bringing the female threaded portion 43 of the large-diameter portion 40B into mesh with the male threaded portion 33 of the cylindrical portion 31.

Between the restricting member 25 and the axial end surface 32 of the cylindrical portion 31 of the rear cover 30, there is interposed a first spacer 51. On the other hand, between the restricting member 25 and the opposing surface 42 of the cap 40, there is interposed a second spacer 52.

Each of the first and second spacers 51 and 52 is formed of a relatively soft metal, such aluminum. Moreover, each of the first and second spacers 51 and 52 is configured to be capable of being plastically deformed to have its axial thickness changed at any position in the circumferential direction. In addition, the first spacer 51 corresponds to a “housing-side spacer” of the DC motor 10; the second spacer 52 corresponds to a “cap-side spacer” of the DC motor 10.

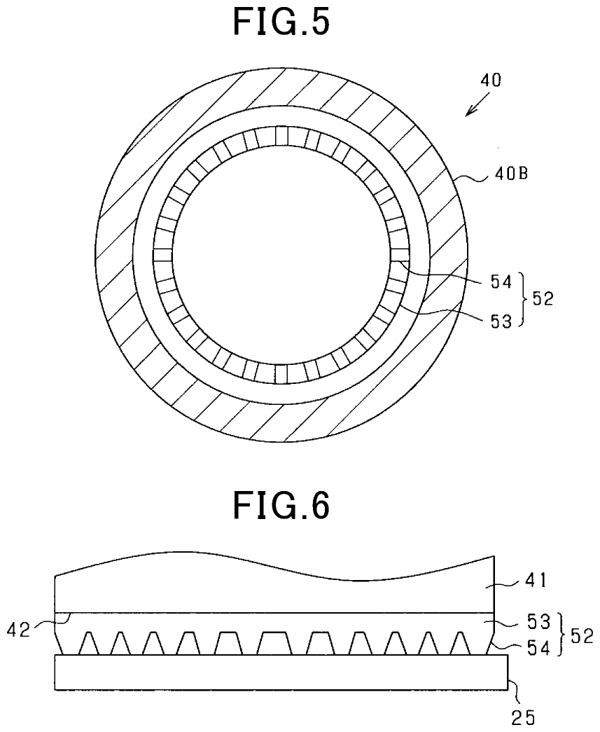

FIG. 4 shows a longitudinal cross section of the cap 40 with the second spacer 52 attached on the opposing surface 42 of the cap 40. FIG. 5 shows a lateral cross section of the cap 40 with the second spacer 52 attached on the opposing surface 42 of the cap 40. FIG. 6 shows the second spacer 52 interposed between the opposing surface 42 of the cap 40 and the restricting member 25.

As shown in FIGS. 4-6, the second spacer 52 has an annular base portion 53 attached on the opposing surface 42 of the cap 40 and a plurality of plastically-deformable portions 54 each of which protrudes from the base portion 53 toward the restricting member 25. The plastically-deformable portions 54 are formed on the base portion 53 in circumferential alignment with each other at predetermined intervals. Each of the plastically-deformable portions 54 is tapered toward the restricting member 25 and has a flat distal end surface. That is, each of the plastically-deformable portions 54 has a trapezoidal shape in side view. It is preferable for the protruding length (or axial dimension) of the plastically-deformable portions 54 to be set so that after the cap 40 is mounted to the cylindrical portion 31 of the rear cover 30, the plastically-deformable portions 54 are in contact with the restricting member 25, but out of contact with the first spacer 51.

When the cap 40 is mounted to the cylindrical portion 31 of the rear cover 30, the plastically-deformable portions 54 of the second spacer 52, which are in contact with the restricting member 25 as shown in FIG. 6, are plastically deformed. More specifically, each of the tapered plastically-deformable portions 54 is crushed from its distal end and thus plastically deformed.

In addition, as described above, in the second spacer 52, the plastically-deformable portions 54 are formed in circumferential alignment with each other at predetermined intervals. During the mounting of the cap 40 to the cylindrical portion 31 of the rear cover 30, a load is imposed on those plastically-deformable portions 54 which abut the restricting member 25. In the case of the cap 40 being oblique (i.e., not perpendicular) to the motor shaft 20, the load imposed on the plastically-deformable portions 54 and thus the degrees of the plastically-deformable portions 54 being crushed by the load vary depending on the circumferential positions thereof. Consequently, with the plastically-deformable portions 54 of the second spacer 52 being crushed in different degrees, it becomes possible to absorb the obliqueness of the opposing surface 42 of the cap 40 to the motor shaft 20.

The first spacer 51 has a similar configuration to the second spacer 52. Specifically, though not shown in the figures, the first spacer 51 also has an annular base portion 53 and a plurality of plastically-deformable portions 54 each protruding from the base portion 53. It is preferable for the protruding length (or axial dimension) of the plastically-deformable portions 54 of the first spacer 51 to be set so that after the restricting member 25 is mounted to the motor shaft 20, the plastically-deformable portions 54 are in contact with the restricting member 25.

In addition, the first spacer 51 may alternatively be configured to have only the base portion 53 without the plastically-deformable portions 54 protruding from the base portion 53. In this case, the base portion 53 may be configured to be plastically deformable in the axial direction.

Moreover, it is preferable for the first and second spacers 51 and 52 to be configured so that the plastically-deformable portions 54 of the second spacer 52 are more easily plastically deformable than the plastically-deformable portions 54 of the first spacer 51. For example, it is possible to set the width of the plastically-deformable portions 54 of the second spacer 52 to be smaller than the width of the plastically-deformable portions 54 of the first spacer 51 and/or set the intervals between the plastically-deformable portions 54 of the second spacer 52 to be larger than the intervals between the plastically-deformable portions 54 of the first spacer 51, thereby making the plastically-deformable portions 54 of the second spacer 52 more easily plastically deformable than the plastically-deformable portions 54 of the first spacer 51. Moreover, it is also possible to form the first and second spacers 51 and 52 with different materials such that the material of the second spacer 52 can be more easily plastically deformed than the material of the first spacer 51. Consequently, when the same force is applied to both the first and second spacers 51 and 52, the second spacer 52 will be plastically deformed earlier than the first spacer 51.

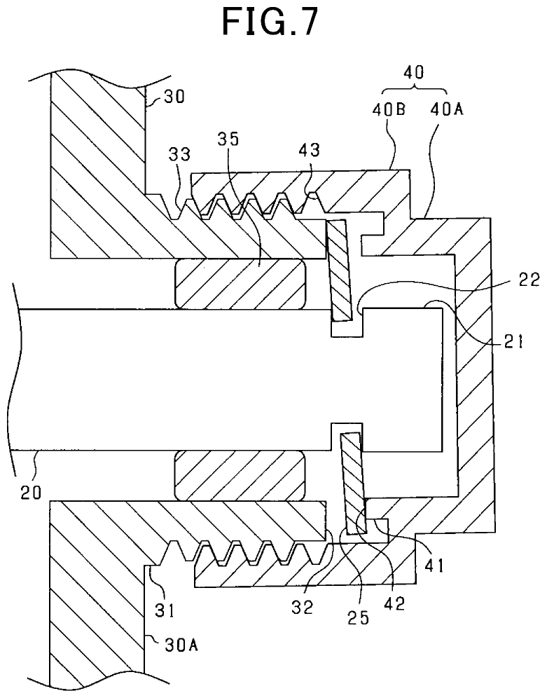

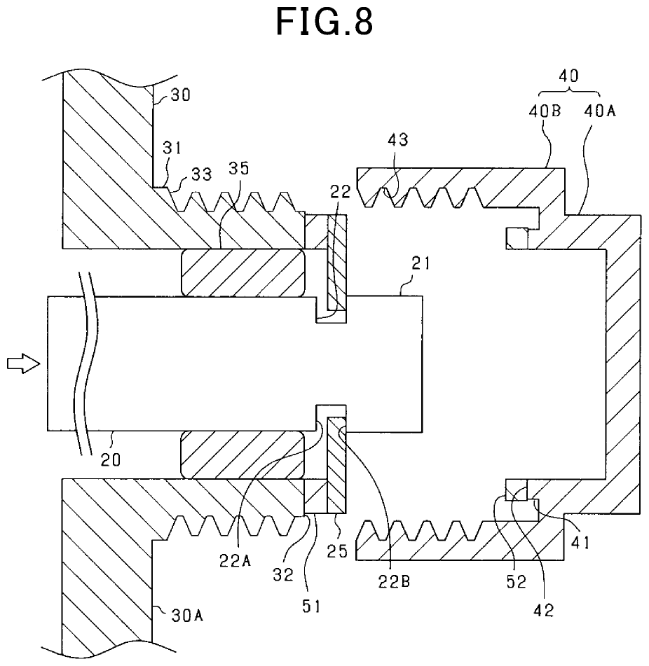

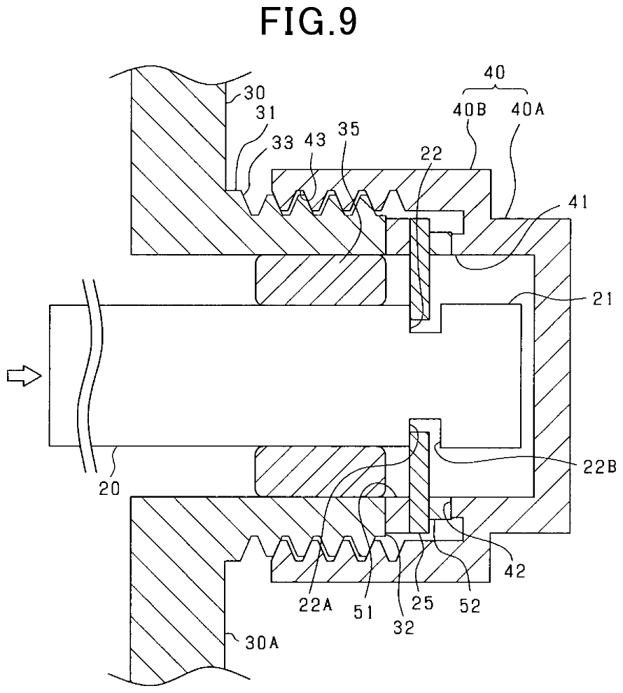

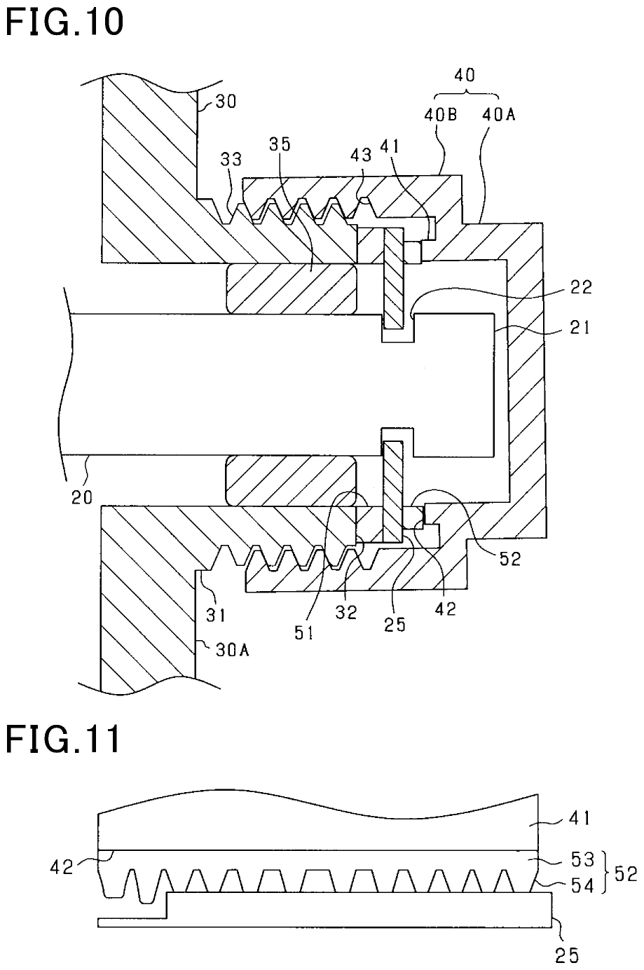

FIG. 7 illustrates a comparative example where the cap 40 is mounted, in a state of being oblique to the motor shaft 20, to the cylindrical portion 31 of the rear cover 30 without any spacer interposed therebetween. In contrast, FIG. 8 illustrates the cap 40 of the DC motor 10 according to the present embodiment before being mounted to the cylindrical portion 31 of the rear cover 30. FIG. 9 illustrates the cap 40 of the DC motor 10 according to the present embodiment in a state of being mounted to the cylindrical portion 31 of the rear cover 30. FIG. 10 illustrates the cap 40 of the DC motor 10 according to the present embodiment which has been mounted, in a state of being oblique to the motor shaft 20, to the cylindrical portion 31 of the rear cover 30.

As described above, the cap 40 is mounted to the cylindrical portion 31 of the rear cover 30 by bringing the female threaded portion 43 of the large-diameter portion 40B of the cap 40 into mesh with the male threaded portion 33 of the cylindrical portion 31 of the rear cover 30.

However, as in the comparative example illustrated in FIG. 7, due to factors such as the machining accuracy of the threaded portions 33 and 43, the cap 40 may be mounted to the cylindrical portion 31 of the rear cover 30 so that: the opposing surface 42 of the cap 40 and the axial end surface 32 of the cylindrical portion 31 are non-parallel to each other; and either or both of the opposing surface 42 of the cap 40 and the axial end surface 32 of the cylindrical portion 31 are not perpendicular, but oblique to the motor shaft 20.

Further, when the opposing surface 42 of the cap 40 and the axial end surface 32 of the cylindrical portion 31 are non-parallel to each other, the restricting member 25 mounted in the annular groove 22 of the motor shaft 20 may become oblique to the motor shaft 20. Moreover, when the opposing surface 42 of the cap 40 and the axial end surface 32 of the cylindrical portion 31 are non-parallel to each other, the restricting member 25 may be placed in a state of being pivotable on a fixed portion thereof that serves as the fulcrum. Consequently, during the engine cranking, the motor shaft 20 may rotate causing axial vibration to the extent corresponding to the degree of obliqueness of the restricting member 25 to the motor shaft 20 and/or the degree of the restricting member 25 being pivotable. Furthermore, depending on the degrees of obliqueness of the opposing surface 42 of the cap 40 and the axial end surface 32 of the cylindrical portion 31 to the motor shaft 20, thereby may be formed gaps between the restricting member 25 and the opposing surface 42 and between the restricting member 25 and the axial end surface 32; these gaps would cause backlash of the restricting member 25 and thus axial runout of the motor shaft 20.

In view of the above, in the DC motor 10 according to the present embodiment, there are provided the first and second spacers 51 and 52 both of which are plastically deformable in the axial direction, thereby suppressing axial runout of the motor shaft 20.

Next, a process of mounting the cap 40 to the cylindrical portion 31 of the rear cover 30 according to the present embodiment will be described with reference to FIGS. 8-10.

First, after the motor shaft 20 is inserted in the bearing 35 that is press-fitted in the cylindrical portion 31 of the rear cover 30, the restricting member 25 is mounted into the annular groove 22 of the motor shaft 20.

In addition, the first spacer 51 may be fixed, for example by bonding, to the axial end surface 32 of the cylindrical portion 31 of the rear cover 30 in advance; and the second spacer 52 may be fixed, for example by bonding, to the opposing surface 42 of the cap 40 in advance.

Then, as shown in FIG. 8, with the motor shaft 20 being pressed backward, the cap 40 is mounted to the cylindrical portion 31 of the rear cover 30. At this time, the restricting member 25, which is supported by the first spacer 51, abuts a rear wall surface (or cap-side wall surface) 22B of the groove 22 of the motor shaft 20, thereby being held in a state of being perpendicular to the motor shaft 20. Moreover, the restricting member 25 is sandwiched between the first spacer 51 and the rear wall surface 22B of the groove 22.

It is preferable for the axial thickness (or the protruding length from the axial end surface 32 of the cylindrical portion 31 of the rear cover 30) of the first spacer 51 to be set so as to ensure contact of the first spacer 51 with the restricting member 25 when the motor shaft 20 is pressed backward and the restricting member 25 abuts the rear wall surface 22B of the groove 22. In addition, in the state of the first spacer 51 being fixed on the axial end surface 32 of the cylindrical portion 31, the rear end (or distal end) of the first spacer 51 may be located backward of a front wall surface (or housing-side wall surface) 22A of the groove 22.

Upon the cap 40 being rotated to bring the female threaded portion 43 of the large-diameter portion 40B of the cap 40 into mesh with the male threaded portion 33 of the cylindrical portion 31 of the rear cover 30, the second spacer 52 fixed on the opposing surface 42 of the cap 40 is bought into contact with the restricting member 25. At this time, the cap 40 is fastened forward applying a pressing force to the first and second spacers 51 and 52. Under the pressing force, the second spacer 52, which is configured to be more easily deformable than the first spacer 51, is plastically deformed to have its axial thickness changed at any position in the circumferential direction. Moreover, during application of the pressing force, the restricting member 25 is supported by the first spacer 51 and thus kept in the state of being perpendicular to the motor shaft 20; the second spacer 52 is plastically deformed to have its entire contact surface adhered to the restricting member 25.

Upon the second spacer 52 being adhered to the restricting member 25, the entire opposing surface 42 of the cap 40 presses the restricting member 25 via the second spacer 52, causing the restricting member 25 to be moved forward while plastically deforming the first spacer 51. Consequently, as shown in FIG. 9, the restricting member 25 is brought into contact with the front wall surface 22A of the groove 22 and thus becomes unable to move forward without increasing the fastening force of the cap 40. Then, the fastening of the cap 40 is terminated. At this time, the restricting member 25 abuts the front wall surface 22A of the groove 22. Therefore, it becomes possible to suppress the restricting member 25 from becoming oblique to the motor shaft 20, thereby minimizing axial runout of the motor shaft 20.

Upon the cap 40 being mounted to the cylindrical portion 31 of the rear cover 30, the backward pressing of the motor shaft 20 is also terminated. Consequently, as shown in FIG. 10, the restricting member 25 is fixed in the groove 22, without being pressed against the front wall surface 22A of the groove 22, in the state of being perpendicular to the motor shaft 20.

In addition, if the restricting member 25 was directly supported by the axial end surface 32 of the cylindrical portion 31 without the first spacer 51 interposed therebetween, upon the restricting member 25 being pressed, in the state of abutting the front wall surface 22A of the groove 22, by the second spacer 52 during the mounting of the cap 40, a radially inner part of the restricting member 25 would be supported by the front wall surface 22A of the groove 22. At this time, there might be formed a gap between a radially outer part of the restricting member 25 pressed by the second spacer 52 and the axial end surface 32 of the cylindrical portion 31.

Moreover, if there was a gap formed between the restricting member 25 and the axial end surface 32 of the cylindrical portion 31, upon the restricting member 25 being pressed forward during the fastening of the cap 40, the pressing force might act in such as manner as to bend the restricting member 25, causing the restricting member 25 to be warped. Consequently, the reaction force of the restricting member 25 to recover the warp thereof might act on one of the wall surfaces of the groove 22, resulting in a frictional resistance between the restricting member 25 and the motor shaft 20 that rotates during the engine cranking.

In view of the above, in the DC motor 10 according to the present embodiment, there is interposed the first spacer 51 between the restricting member 25 and the axial end surface 32 of the cylindrical portion 31. Therefore, during the mounting of the cap 40, the first spacer 51, which supports the restricting member 25 from the front side, is plastically deformed until the axial position of the rear end of the first spacer 51 becomes coincident with the axial position of the front wall surface 22A of the groove 22. Consequently, no gap is formed between the restricting member 25 and the first spacer 51; thus, no force acts in such as manner as to bend the restricting member 25. As a result, it becomes possible to prevent the restricting member 25 from being warped, thereby minimizing axial runout of the motor shaft 20.

Moreover, in the DC motor 10 according to the present embodiment, there are provided both the first and second spacers 51 and 52. Consequently, it becomes possible to fix the restricting member 25 to be perpendicular to the motor shaft 20 even when the opposing surface 42 of the cap 40 and the axial end surface 32 of the cylindrical portion 31 are non-parallel to each other. For example, as shown in FIG. 10, when the cap 40 is mounted to be oblique to the motor shaft 20, the opposing surface 42 of the cap 40 and the axial end surface 32 of the cylindrical portion 31 are non-parallel to each other. During the mounting of the cap 40, the second spacer 52, which is more easily deformable than the first spacer 51, is plastically deformed to have its axial thickness changed at any position in the circumferential direction. Consequently, with the restricting member 25 fixed to be perpendicular to the motor shaft 20, axial runout of the motor shaft 20 can be suppressed. As a result, it becomes possible to suppress axial movement of the commutator 15 fixed on the motor shaft 20, thereby suppressing wear of the brushes 16.

According to the present embodiment, it is possible to achieve the following advantageous effects.

In the present embodiment, the brushed DC motor 10, which is designed to be used in the starter S of the internal combustion engine, includes the rear cover (or housing) 30, the motor shaft 20, the cap 40, the restricting member 25 and the second spacer (or cap-side spacer) 52. The rear cover 30 has the hollow cylindrical portion 31 in which the bearing 35 is fixed. The cylindrical portion 31 has the axial end surface 32. The motor shaft 20 is rotatably supported by the rear cover 30 via the bearing 35. The motor shaft 20 has the protruding portion 21 that protrudes from the cylindrical portion 31 of the rear cover 30 so as to be located outside the rear cover 30. The motor shaft 20 also has the annular groove 22 formed in the outer circumferential surface of the protruding portion 21. The cap 40 is mounted to the cylindrical portion 31 of the rear cover 30 to cover the protruding portion 21 of the motor shaft 20. The cap 40 has the opposing surface 42 opposed to the axial end surface 32 of the cylindrical portion 31 of the rear cover 30. The restricting member 25 is mounted in the annular groove 22 of the motor shaft 22 and fixed between the axial end surface 32 of the cylindrical portion 31 of the rear cover 30 and the opposing surface 42 of the cap 40 to restrict axial movement of the motor shaft 20. The second spacer 52 is interposed, in the state of having been plastically deformed in the axial direction of the motor shaft 20 during the mounting of the cap 40 to the cylindrical portion 31 of the rear cover 30, between the opposing surface 42 of the cap 40 and the restricting member 25 in the axial direction.

With the above configuration, between the opposing surface 42 of the cap 40 and the restricting member 25, there is interposed the second spacer 52 which has been plastically deformed in the axial direction of the motor shaft 20 during the mounting of the cap 40 to the cylindrical portion 31 of the rear cover 30. Therefore, even when the opposing surface 42 of the cap 40 is non-parallel to the axial end surface 32 of the cylindrical portion 31 of the rear cover 30 during the mounting of the cap 40 to the cylindrical portion 31, the second spacer 52 can be plastically deformed to have its axial thickness changed at any position in the circumferential direction, thereby allowing the restricting member 25 to be pressed over the entire circumferential range thereof by the cap 40. Consequently, it becomes possible to have the restricting member 50 fixed to be perpendicular to the motor shaft 20 while having both the opposing surface 42 of the cap 40 and the axial end surface 32 of the cylindrical portion 31 of the rear cover 30 adhered to the restricting member 25 without any gap formed between the surfaces 42 and 32 and the restricting member 25. As a result, it becomes possible to suppress axial runout of the motor shaft 20.

Moreover, in the present embodiment, the DC motor 10 further includes the first spacer (or housing-side spacer) 51 that is interposed, in the state of having been plastically deformed in the axial direction of the motor shaft 20 during the mounting of the cap 40 to the cylindrical portion 31 of the rear cover 30, between the axial end surface 32 of the cylindrical portion 31 of the rear cover 30 and the restricting member 25 in the axial direction.

The axial end surface 32 of the cylindrical portion 31 of the rear cover 30 may be oblique to the motor shaft 20 due to, for example, manufacturing tolerances. In this case, with the first spacer 51 interposed between the axial end surface 32 and the restricting member 25, it is still possible to reliably ensure the perpendicularity of the restricting member 25 to the motor shaft 20 through the plastic deformation of the first spacer 51 during the mounting of the cap 40 to the cylindrical portion 31 of the rear cover 30.

Moreover, to minimize axial runout of the motor shaft 20, it is preferable to press, during the mounting of the cap 40 to the cylindrical portion 31 of the rear cover 30, the second spacer 52 against the restricting member 25 with the restricting member 25 abutting the front wall surface 22A of the groove 22. If there was no first spacer 51 interposed between the axial end surface 32 of the cylindrical portion 31 and the restricting member 25, upon the radially outer part of the restricting member 25 being pressed by the cap 40 via the second spacer 52 with the radially inner part of the restricting member 25 abutting the front wall surface 22A of the groove 22, the restricting member 25 might be warped. In this regard, by interposing the first spacer 51 between the axial end surface 32 of the cylindrical portion 31 and the restricting member 25, it becomes possible to prevent the restricting member 25 from being warped.

In the present embodiment, the second spacer 52 is configured to be more easily plastically deformable than the first spacer 51.

As described above, by providing the first and second spacers 51 and 52 respectively on the rear cover 30 side (or housing side) and the cap 40 side of the restricting member 25, it becomes possible suppress the influence of obliqueness of the opposing surface 42 of the cap 40 and the axial end surface 32 of the cylindrical portion 31 to the motor shaft 20 on the restricting member 25. Moreover, during the mounting of the cap 40 to the cylindrical portion 31 of the rear cover 30, it is easier for the opposing surface 42 of the cap 40 to become oblique to the motor shaft 20 (due to, for example, assembly errors) than for the axial end surface 32 of the cylindrical portion 31 to become oblique to the motor shaft 20. However, by configuring the second spacer 52 to be more easily plastically deformable than the first spacer 51, it becomes possible to reliably suppress the influence of obliqueness of the opposing surface 42 of the cap 40 to the motor shaft 20 on the restricting member 25.

In the present embodiment, the restricting member 25 is substantially C-shaped and arranged around the motor shaft 20. The second spacer 52 has the plastically-deformable portions 54 formed in circumferential alignment with each other. Moreover, those of the plastically-deformable portions 54 which abut the restricting member 25 in the axial direction of the motor shaft 20 are in the state of having been plastically deformed in the axial direction during the mounting of the cap 40 to the cylindrical portion 31 of the rear cover 30.

With the above configuration, in the case of the cap 40 being oblique to the motor shaft 20 during the mounting of the cap 40 to the cylindrical portion 31 of the rear cover 30, the load imposed on the plastically-deformable portions 54 and thus the degrees of the plastically-deformable portions 54 being crushed by the load vary depending on the circumferential positions thereof. Consequently, with the plastically-deformable portions 54 of the second spacer 52 being crushed in different degrees, it becomes possible to absorb the obliqueness of the opposing surface 42 of the cap 40 to the motor shaft 20.

While the above particular embodiment has been shown and described, it will be understood by those skilled in the art that various modifications, changes, and improvements may be made without departing from the spirit of the present disclosure.

(1) For example, FIG. 11 illustrates a restricting member 25 according to a modification in a state of being pressed by the cap 40 via the second spacer 52 interposed therebetween. In this modification, the restricting member 25 is annular-shaped so as to be continuous in the circumferential direction. Moreover, the restricting member 25 has a non-abutting portion formed within a given circumferential range; the non-abutting portion is recessed from the rear end surface (i.e., the end surface facing the second spacer 52) of the restricting member 25 so as not to abut the second spacer 52. That is, the restricting member 25 has both the non-abutting portion and an abutting portion arranged in the circumferential direction; the abutting portion abuts the second spacer 52. In other words, the restricting member 25 abuts the second spacer 52 over the entire circumferential range of the restricting member 25 except for the given circumferential range of the non-abutting portion. In this case, at least one of the plastically-deformable portions 54 of the second spacer 52 is pressed into the non-abutting portion of the restricting member 25 during the mounting of the cap 40 to the cylindrical portion 31 of the rear cover 30, thereby functioning as a positioning member to position the restricting member 25 in the circumferential direction. Consequently, the restricting member 25 can be fixed at a predetermined position without being displaced therefrom.

(2) The first spacer 51 may alternatively be formed to have its plastically-deformable portions 54 provided on the rear end of the cylindrical portion 31 of the rear cover 30. Similarly, the second spacer 52 may alternatively be formed to have its plastically-deformable portions 54 provided on the front end (or distal end) of the protrusion 41 of the cap 40.

(3) The cap 40 may alternatively be fixed to the cylindrical portion 31 of the rear cover 30 by a method which does not rotate the cap 40, for example by crimping.

(4) The cap 40 may alternatively be fixed to an outer circumferential surface of the rear cover 30 instead of the cylindrical portion 31 of the rear cover 30.

What is claimed is:

1. A brushed DC motor for a starter of an internal combustion engine, the DC motor comprising:
a housing having a hollow cylindrical portion in which a bearing is fixed, the cylindrical portion having an axial end surface;
a motor shaft rotatably supported by the housing via the bearing, the motor shaft having a protruding portion that protrudes from the cylindrical portion of the housing so as to be located outside the housing, the motor shaft also having an annular groove formed in an outer circumferential surface of the protruding portion;
a cap mounted to the cylindrical portion of the housing to cover the protruding portion of the motor shaft, the cap having an opposing surface opposed to the axial end surface of the cylindrical portion of the housing;
a restricting member mounted in the annular groove of the motor shaft and fixed between the axial end surface of the cylindrical portion of the housing and the opposing surface of the cap to restrict axial movement of the motor shaft; and
a spacer interposed, in a state of having been plastically deformed in an axial direction of the motor shaft during the mounting of the cap to the cylindrical portion of the housing, between the opposing surface of the cap and the restricting member in the axial direction.

2. The DC motor as set forth in claim 1, wherein the spacer is a cap-side spacer, and
the DC motor further comprises a housing-side spacer that is interposed, in a state of having been plastically deformed in the axial direction of the motor shaft during the mounting of the cap to the cylindrical portion of the housing, between the axial end surface of the cylindrical portion of the housing and the restricting member in the axial direction.

3. The DC motor as set forth in claim 2, wherein the cap-side spacer is configured to be more easily plastically deformable than the housing-side spacer.

4. The DC motor as set forth in claim 1, wherein the restricting member is substantially C-shaped and arranged around the motor shaft,
the spacer has a plurality of plastically-deformable portions formed in circumferential alignment with each other, and
those of the plurality of plastically-deformable portions which abut the restricting member in the axial direction of the motor shaft are in the state of having been plastically deformed in the axial direction during the mounting of the cap to the cylindrical portion of the housing.

5. The DC motor as set forth in claim 1, wherein the restricting member is annular-shaped and has a non-abutting portion,
the non-abutting portion is formed within a given circumferential range so as not to abut the spacer, and
the restricting member abuts the spacer over an entire circumferential range of the restricting member except for the given circumferential range of the non-abutting portion.
